(19) United States
(12) Patent Application Publication
(10) Pub. No.: US 2005/0216525 A1
(43) Pub. Date: Sep. 29, 2005

(54) Defining target group for marketing campaign

(76) Inventors: Andre Wachholz-Prill, Bellheim (DE); Wolfram Dithmar, Blieskastel (DE); Chaitanya Kudumula, Walldorf (DE); Andre Axtmann, Saarbruecken (DE); Klaus Brengel, Heusweller (DE); Anja Gerstmair, Walldorf (DE)

Correspondence Address: FISH & RICHARDSON, P.C., PO BOX 1022, MINNEAPOLIS, MN, 55440-1022, US

(21) Appl. No.: 11/052,561

(22) Filed: Feb. 7, 2005

Related U.S. Application Data
(60) Provisional application No. 60/556,649, filed on Mar. 26, 2004.

(51) Int. Cl. G06F 17/60; G06F 7/00; G06F 17/00; G06F 12/00; G06F 17/30

(52) U.S. Cl. 707/201; 705/14

(57) ABSTRACT

A method to be performed when a user is defining a target group for a marketing campaign includes receiving an input identifying an attribute value chosen by a user for determining which of several possible members to include in a target group. A first data repository contains data about each of the several possible members. The method includes determining whether the data that is associated with the attribute value has been loaded from the first data repository into a second data repository. If the data that is associated with the attribute value has been loaded into the second data repository, the method includes initiating a search in the second data repository with the attribute value to determine which of the several possible members to include in the target group. The second data repository may be configured to provide high-speed searching.

### RELATED APPLICATION

This application claims priority from U.S. Provisional Application Ser. No. 60/556,649, filed Mar. 26, 2004, the contents of which are incorporated herein by reference.

### TECHNICAL FIELD

This description relates to defining a target group for a marketing campaign.

### BACKGROUND

Target groups for marketing campaigns can be defined using a segment builder application program. In a modeling phase, a user may enter one or more attribute values to create a customer profile in the segment builder, where the customer profile when finished can be used to search a data repository of customer records for the customer(s) matching the profile. The segment builder typically includes a graphical user interface (GUI) with which the user selects between different attributes and can see a representation of the modeled target group, for example as a distribution of different customers. The modeling phase may take place during the planning stage of the marketing campaign. The target group will be actualized and used during execution of the marketing campaign. For simplicity, this description will refer to any target group member as a customer although marketing campaigns also may be directed at non-customers.

In the modeling phase, the user may run one or more searches on the database with the customer profile to determine how many customers the current profile includes. That is, for instance, the marketing campaign may be intended for a certain size target group and the purpose of defining the customer profile is to select approximately that many customers from the database that all have some desired characteristic. If the database is extensive and only partially indexed, as is often the case, a search can take relatively long time, up to an hour or more. For this reason, searches are often sent off as offline batch jobs.

In addition, the person creating the customer profile usually is a member of the organization's marketing department and may not be able to estimate the number of hits for a specific customer profile. This means that when the search finally is finished, it may result in a far too small—or large—target group for the campaign. The target group designer must then remove one or more attributes from the profile if the target group ended up too small, or add attributes if the group became too large, and run the search again. One disadvantage of this time-consuming process is that it may be difficult to fine-tune the customer profile to get the right target group for the campaign. Another disadvantage is that the slow searching may deter users from even trying to model a target group in some situations.

The difficulties in performing extensive searches has prompted the use of customer base samples in some systems. That is, there may be identifies a sample of the total customer base and the search may be performed on this sample segment to determine how many customers the profile can be expected to generate for the target group. Disadvantages in this approach are that a sample is not always representative and that the search results cannot identify the actual customers that will be included in the target group (at least not those that are not part of the sample).

### SUMMARY

The invention relates to defining a target group for a marketing campaign.

In a first general aspect, a method to be performed when a user is defining a target group for a marketing campaign comprises receiving an input identifying an attribute value chosen by a user for determining which of several possible members to include in a target group, wherein a first data repository contains data about each of the several possible members. The method comprises determining whether the data that is associated with the attribute value has been loaded from the first data repository into a second data repository. If the data that is associated with the attribute value has been loaded into the second data repository, the method comprises initiating a search in the second data repository with the attribute value to determine which of the several possible members to include in the target group.

In selected embodiments, the search may involve counting the members that the search yields. In other embodiments, the search may identify the members.

Search results may be presented to a user as a distribution. In some embodiments, presented search results are obtained by merging results from searching more than one repository.

In a second general aspect, a method to be performed when a user is defining a target group for a marketing campaign comprises receiving an input identifying attribute values chosen by a user for determining which of several possible members to include in a target group. If data associated with any of the attribute values has been loaded from a first data repository into a second data repository, the method comprises initiating a search in the second data repository with those attribute values. If there exists a remainder of the attribute values whose data has not been loaded into the second data repository, the method comprises searching the first data repository with the remainder of the attribute values.

Advantages of the systems and techniques described herein may include any or all of the following: Improving target group modeling for a marketing campaign; providing target group modeling with interactive searching; providing that a user can define a target group using online searching among relevant attribute values; providing that a user can model a target group using a dialog search; facilitating that attributes can be defined for loading attribute values assigned to customer records to a high-speed secondary data repository for online profile modeling; providing users with a high-speed online customer segmentation based on a fast interactive search technology that can find items instantly in large volumes of data; shortening the segment modeling phase by enabling users to slice and dice customer data spontaneously and interactively in order to build meaningful target groups for a marketing campaign; improving segmentation accuracy; leveraging return on investment in scenarios where fast analysis can open up new business opportunities, for example in identifying and targeting drive-by prospects for wireless promotion; handling extremely large numbers of customer records in dialog processes; minimizing total cost of operation with self-administration and monitoring, dynamic self-configuration, and automatic fail over recovery, and backup.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system in which a target group can be defined;

FIGS. 2A and 2B are examples of a GUI that the system shown in FIG. 1 can present;

FIG. 3 is another example of a GUI that the system shown in FIG. 1 can present;

FIGS. 4 and 5 are embodiments of inventive methods; and

FIG. 6 is a block diagram of a general computer system.

Like reference numerals in the various drawings indicate like elements.

### DETAILED DESCRIPTION

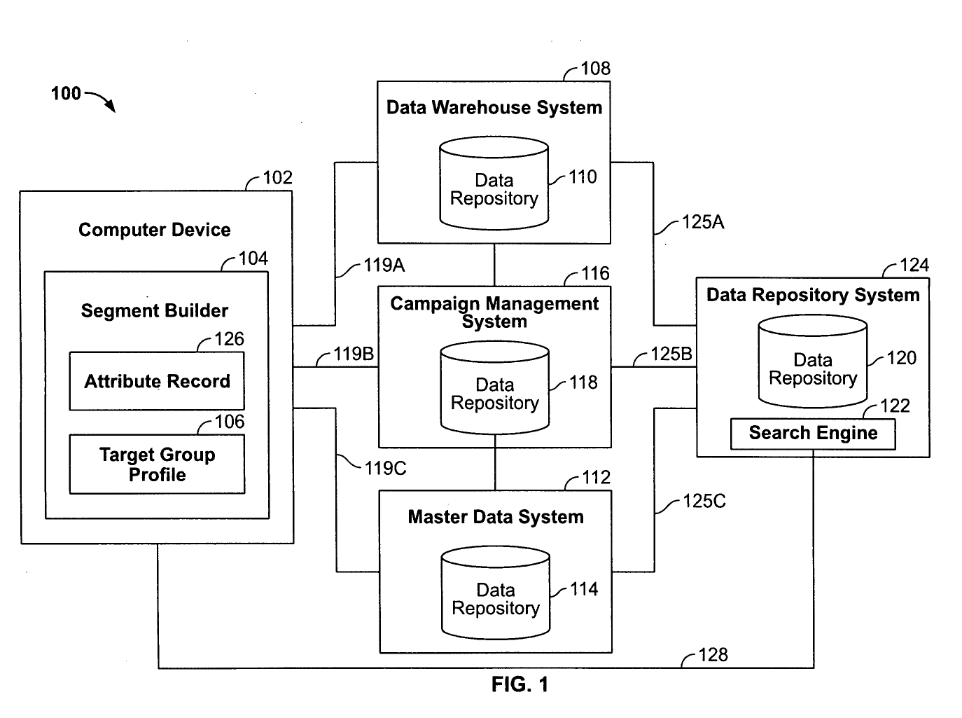

FIG. 1 shows a computer system 100 in which a target group can be modeled and created. The system includes a computer device 102 on which a segment builder application program 104 is available to users. The segment builder 104 lets a user select one or more attribute values for a target group profile 106 and is associated with an improved technique for searching the relevant record(s) as part of modeling a target group profile. Particularly, a user can perform interactive searches to determine how many customers match a specific target group profile.

The values that are associated with the different attributes recognized by the segment builder may be stored in one or more components of the system 100. For example, a data warehouse system 108 may include a data repository 110 (“the DW repository”) to which selected data in the system 100 is replicated for additional processing, such as online analytical processing. For example, attribute values stored in the DW repository may reflect which customers have made purchases in the last three months.

As another example, a master data system 112 may include a data repository 114 (“the MD repository”) in which is stored master records of the various customers. For example, attribute values stored in the MD repository may reflect information that seldom changes, such as a customer's name or address, or permanent information, such as a customer's date of birth.

As another example, a campaign management system 116 may include a data repository 118 (“the CM repository”), which includes attribute values specifically registered for purposes of performing marketing campaigns. For example, attribute values stored in the CM repository may reflect personal information that the customers voluntarily provide in surveys or application forms, such as the customers' hobbies or other personal interests. In some implementations, the computer device 102 is part of the campaign management system, and the campaign management system can be used for launching the marketing campaign that is directed at the created target group. For example, the campaign management system may be part of a customer relations management (CRM) system.

It may be possible to search for any of the above-mentioned exemplary attribute values directly in the respective DW, MD and CM repositories. For example, the segment builder may access these repositories through respective connections 119A, B or C. Such searching may, however, take a long time if the repository is large, or may otherwise be disruptive. It is therefore useful to use a secondary repository with a fast searching mechanism, as will be exemplified below, because this may produce essentially instant results. This is particularly helpful when the DW repository often experiences a high load of data requests and uploads from other backend systems, such as a CRM system.

Some attribute values may be loaded from one or more of the DW, MD and CM systems into another data repository 120 that is associated with a search engine 122 and that may be located in a data repository system 124. For example, loading may be performed through respective connections 125A, B or C by running searches for all values of a particular attribute. The repository 120, in turn, may be optimized for fast downloading of attribute values; that is, performing searches and delivering the results. The data repository 120 and the search engine 122 may permit interactive searches where the user can almost instantaneously see the results. Because the searching is relatively fast, it is possible for the user to remain online while the search is being performed. The data repository 120 may comprise a main memory-resident data storage for fast interactive search and analysis of large volumes of structured data with sub critical update requirements. For example, the fast searching in the data repository 120 may be accomplished using algorithms in computational linguistics, statistical natural language processing and machine learning. The data repository 120 can include the following features, to name a few examples: automatic information structuring is supported, documents are automatically classified into taxonomies, multiple languages and repositories are indexed, internal and external information is integrated, and structured data in transactional systems can be accessed.

Due to these advantages, it may be desirable to load into the data repository 120 those attributes whose values are often used in creating target groups. However, some attribute values may be better candidates for loading than others. For example, an attribute whose value changes very often may be a poor candidate for loading because the data repository 120 may then quickly become out of date. In contrast, attribute values that are more stable may be better candidates for loading.

The following are examples of operations in the system 100. A user wants to model the target group profile 106 for a particular campaign. It has been determined that the campaign should be directed at customers that are 30-35 years old and whose hobbies include soccer or golf. The user therefore launches the segment builder 104 and enters the just mentioned characteristics as values for an “Age” attribute and a “Hobby” attribute, respectively. For example, the user makes an input, supported by the GUI, that identifies the selected attribute values.

The segment builder determines whether data that is associated with these attribute values—that is, the stored customer data that is to be searched for matching customers—has been loaded into the data repository 120. For example, the segment builder may consult an attribute record 126 that identifies the loaded attributes, or non-loaded attributes, or both. It will be described below how a user can create the attribute record 126.

Here, the data that is associated with the Age attribute is stored in the MD repository and the data that is associated with the Hobby attribute is stored in the CM repository. The respective data may include an association between the customer(s) and one of these attribute values. For example, the customer is identified by a customer name or account number. Moreover, the attribute record 126 reflects that the data of both these attributes has been loaded into the data repository 120.

The segment builder therefore accesses the data repository system 124 through a connection 128 and initiates a search for any customer(s) matching these attribute values. The search may be interactive and the computer device may remain online with the data repository system 124 while it is being performed. For example, the segment builder invokes the search engine 122 to perform the search. The search results may then be displayed to the user in a GUI generated on the computer device 102.

To mention two examples, the search may involve counting or identifying the resulting customer(s). With counting, the search result is the number of customers that would be included in the target group if it were created at this time. The result may be displayed to the user as a distribution, for example to show the relative proportions between customers matching the alternative Hobby attributes soccer and golf, respectively. Counting the resulting customers is useful when the user wants to know if the current target group profile will generate a target group of acceptable size. Accordingly, counting the customers may be done without retrieving any customer identifiers (such as customer names or account numbers), which are typically included in the target group when it is created. The approach of counting the customers that fit a particular profile can be performed on a sample of customers, for example included in the data repository 120. Identifying the customers, in contrast, may involve retrieving such unique customer information and this approach may be useful in situations such as the following example.

Assume that the user that is modeling the customer profile also wants it to take into account when the customer's most recent purchase took place. In addition to the Age and Hobby attribute values, the user therefore specifies that the matching customer(s) shall have made a purchase in the last three months. This value relates to a Most Recent Purchase attribute. In this example, the data that is associated with the Most Recent Purchase value is stored in the DW system. Moreover, the segment builder determines that this data has not been loaded into the data repository 120. The segment builder therefore initiates a search in the DW system though the connection 119A. Essentially at the same time, the segment builder initiates the search of the data repository 120. Here, each of these searches produces the name (or other unique information) of any and all customers that match the attribute value(s). The segment builder can thereafter merge the customer identifiers received in the respective searches to produce a list of the customers that meet each of the three characteristics.

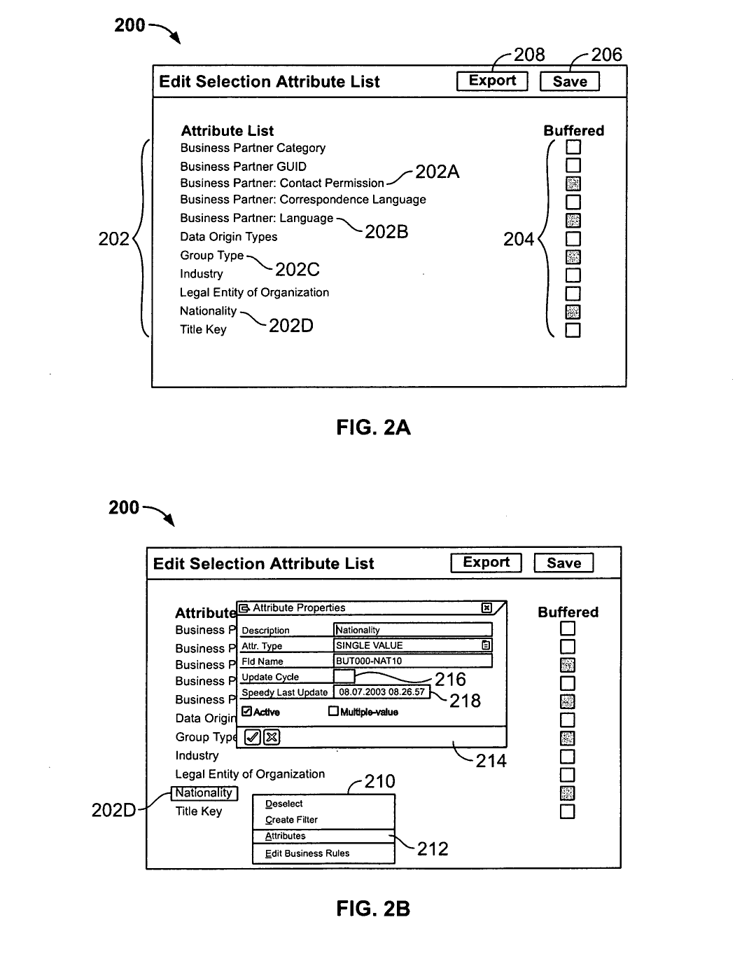

FIGS. 2A and 2B are examples of a GUI that can be generated on the computer device 102, for example through the segment builder 104. The GUI 200 lets the user select one or more attributes for loading into the data repository 120 and also lets the user initiate such loading. Accordingly, the GUI 200 may be used to create, or may be a visual representation of, the attribute record 126.

The GUI 200 includes an attribute list 202 that lists attributes recognized by the segment builder. The listed attributes may relate to data stored in one or more of the DW, MD or CM repositories. Here, the listed attributes relate to every customer and other entity that the user has business contacts with. These are collectively referred to as “Business Partners”. For example, the list 202 includes attributes such as Business Partner: Contact Permission (202A), Business Partner: Language (202B), Group Type (202C) and Nationality (202D). In a Buffered column 204, the user can select any or all attributes in the list 202. The data associated with any selected attribute will be loaded into the data repository 120. Here, the user has selected the attributes 202A-D in the column 204. The user can save this setting (for example to generate the attribute record 126) using a Save button 206. The actual loading of the data for the selected attributes can be initiated using an Export button 208.

As another example, the exporting can be scheduled to take place at certain times. The user can specify this as shown in FIG. 2B. The user can select one of the attributes such as the Nationality 202D and open a context menu 210 associated therewith, for example by clicking a right mouse button. The context menu 210 includes an Attributes command 212 that, upon user selection, triggers a popup window 214 for specifying properties of the selected attribute. For example, the popup window includes input fields for the selected attribute's description and attribute type. An Update Cycle field 216 in the popup window lets the user specify how often data associated with the selected attribute is automatically loaded to the data repository 120, the update cycle being measured in a specific unit of time. Moreover, the popup window includes an output field 218 that specifies when data for this attribute was most recently loaded.

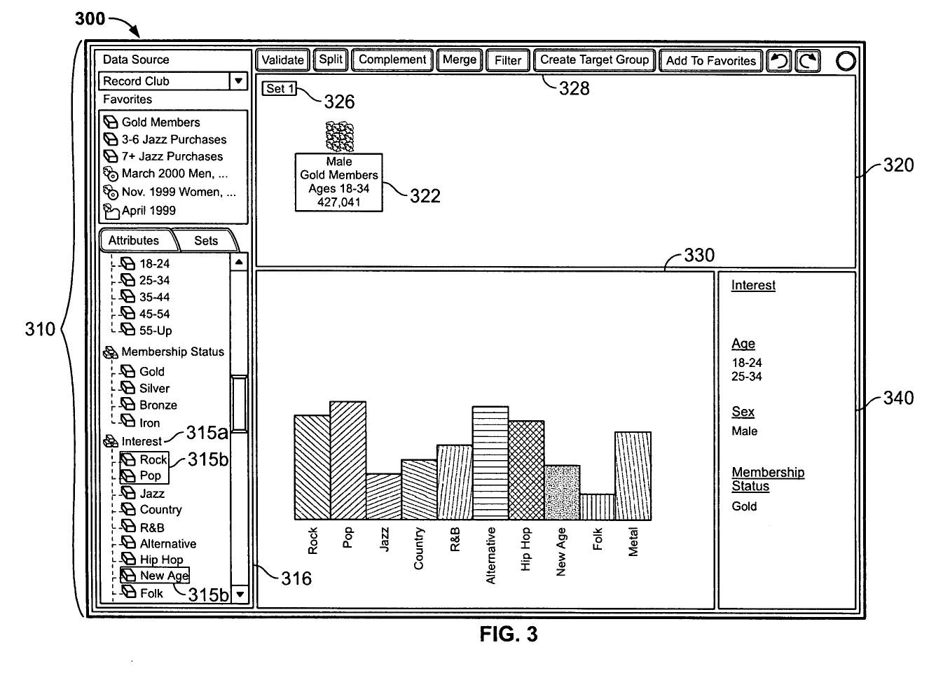

FIG. 3 shows an exemplary GUI 300 that can be used in modeling, and later creating, the target group profile 106. GUI 300 includes components window 310, modeling window 320, information window 330, and text description window 340. Components window 310 may display component aspects of a data source. In this exemplary illustration, components window 310 further includes data source window 312, favorites window 314, and data attributes window 316. The favorites window 314 and the data attributes window 316 provide graphical representation of different aspects of the selected data source. In general, the data attributes window 316 includes one or more graphical representations of data attributes, which represent valid entries for one or more fields or categories from the data source.

Data source window 312 indicates that the data source in this example relates to a record club. Information about members of the record club may be stored in one or more repositories. For example, stable information such as age and membership status may be stored in the MD repository, while other information such as music preferences may be stored in the CM repository. Moreover, the attribute record 124 indicates whether any of the attributes for the record club members have been loaded into the data repository 120.

In modeling window 320 there may be performed actions based on user inputs, and there may be displayed graphical representations of one or more searches done in the one or more repositories. In one implementation, graphical representations may be dragged from the components window 310 (e.g., the favorites window 314 or the data attributes window 316) or from the information window 330 and dropped in the modeling window 320.

Here, a segment representation 322 is displayed in the modeling window 320, for example upon a user dragging and dropping it there. The segment representation is a result of searching for record club members that fit specified criteria, which searches may involve counting or identifying those members. The segment representation 322 includes male “Gold Members” that are 18-34 years old. Currently, this segment representation would generate a target group consisting of 427,041 people.

The user may select a data attribute category such as Membership Status or Interest. Here, the user selects a category 315a for displaying a distribution based on member Interest. Alternatively, the user could have selected one or more subcategories 315b in the components window 310. For example, a sub-category selection may include more than one Interest, such as Rock, Pop and New Age as shown. The information window 330 currently displays a graphical representation of a distribution of members according to the selected data attribute category 315a (i.e., Interest). The distribution may provide the user substantially real-time feedback as to how the segment representation 322 in the modeling window 320 would be affected by the selection of the data attribute sub-category 315b (i.e., Rock, Pop, New Age).

In this example, the distribution in the information window 330 is a bar graph; however, other types of distributions may be presented and the user may change the type of segment representation. When the user selects a data attribute sub-category 315b to refine a segment in the modeling window 320, the text description window is updated and reflects each of the data attribute sub-categories that are assignment to the segment. Additionally, the user may define a name 326 for the customer profile that includes the segment representation 322; here “Set 1”. Moreover, the user can initiate creation of the target group, which typically is performed some time after the modeling, by clicking on a Create Target Group control 328.

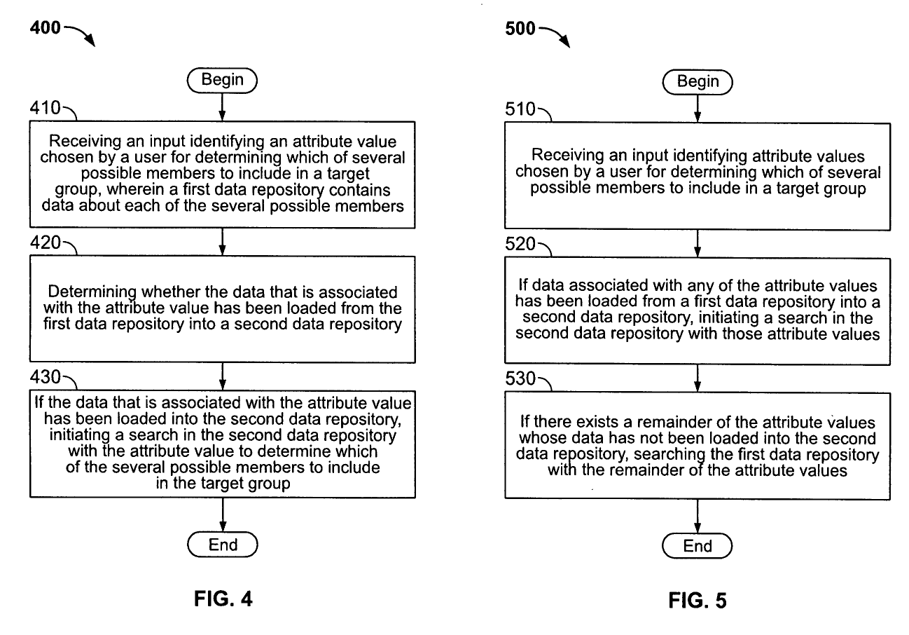

FIGS. 4 and 5 are flow charts of methods 400 and 500, respectively. The methods 400 and 500 may be performed in the system 100. For example, a computer program product may include instructions that cause a processor to perform operations comprising the steps of any or both of the methods. As shown in FIG. 4, the method 400 includes the following steps:

Receiving, in step 410, an input identifying an attribute value chosen by a user for determining which of several possible members to include in a target group, wherein a first data repository contains data about each of the several possible members. For example, the computer device 102 may receive the input when the user specifies a Hobby attribute value to be used in a customer profile, wherein the CM repository 116 contains data about customer hobbies.

Determining, in step 420, whether the data that is associated with the attribute value has been loaded from the first data repository into a second data repository. For example, the computer device may access the attribute record 126 to determine whether data for the Hobby attribute has been loaded into the data repository 120.

If the data that is associated with the attribute value has been loaded into the second data repository, the method 400 comprises initiating, in step 430, a search in the second data repository with the attribute value to determine which of the several possible members to include in the target group. For example, the computer device 102 can access the data repository system through connection 128 and trigger the search engine 122 to perform the specified search in the data repository 120. For example, the search involves counting or identifying the matching members.

As shown in FIG. 5, the method 500 comprises the following steps:

Receiving, in step 510, an input identifying attribute values chosen by a user for determining which of several possible members to include in a target group. For example, the computer device 102 may receive the input when the user is modeling a customer profile, the input specifying values for the Age, Hobby and Most Recent Purchase attributes.

If data associated with any of the attribute values has been loaded from a first data repository into a second data repository, initiating a search in the second data repository with those attribute values. For example, data associated with the Age and Hobby attributes has been loaded into the data repository 120, and the computer device 102 initiates a search with those attribute values using the connection 128. The search result may be names or other identifiers for the matching customers.

If there exists a remainder of the attribute values whose data has not been loaded into the second data repository, searching the first data repository with the remainder of the attribute values. For example, the data associated with the Most Recent Purchase attribute is stored in the DW repository and has not been identified for loading into the data repository 120 (perhaps because it is subject to frequent changes). The computer device searches the DW repository with that attribute value using the connection 119A. The search result may be names or other identifiers for matching customers. A total result may be formed by merging (i) the results of searching the data repository 120 with value(s) for loaded attributes, and (ii) the results of searching any or all of the DW, MD and CM repositories with values for unloaded attributes.

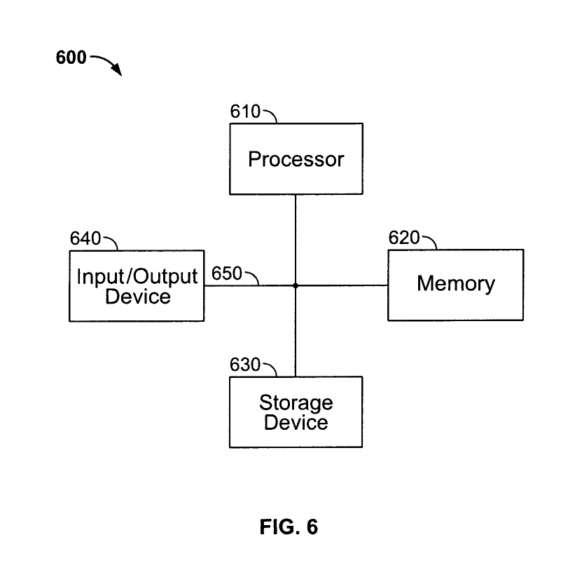

FIG. 6 is a block diagram of a computer system 600 that can be used in the operations described above, according to one embodiment. For example, the system 600 may be included in any or all of the computer device 102, data warehouse system 108, campaign management system 116, master data system 112 and data repository system 124.

The system 600 includes a processor 610, a memory 620, a storage device 630 and an input/output device 640. Each of the components 610, 620, 630 and 640 are interconnected using a system bus 650. The processor 610 is capable of processing instructions for execution within the system 600. In one embodiment, the processor 610 is a single-threaded processor. In another embodiment, the processor 610 is a multi-threaded processor. The processor 610 is capable of processing instructions stored in the memory 620 or on the storage device 630 to display graphical information for a user interface on the input/output device 640.

The memory 620 stores information within the system 600. In one embodiment, the memory 620 is a computer-readable medium. In one embodiment, the memory 620 is a volatile memory unit. In another embodiment, the memory 620 is a non-volatile memory unit.

The storage device 630 is capable of providing mass storage for the system 600. In one embodiment, the storage device 630 is a computer-readable medium. In various different embodiments, the storage device 630 may be a floppy disk device, a hard disk device, an optical disk device, or a tape device.

The input/output device 640 provides input/output operations for the system 600. In one embodiment, the input/output device 640 includes a keyboard and/or pointing device. In one embodiment, the input/output device 640 includes a display unit for displaying graphical user interfaces. For example, each or both of the GUIs 200 and 300 can be generated for display on the input/output device 640.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method to be performed when a user is defining a target group for a marketing campaign, the method comprising:
receiving an input identifying an attribute value chosen by a user for determining which of several possible members to include in a target group, wherein a first data repository contains data about each of the several possible members;
determining whether the data that is associated with the attribute value has been loaded from the first data repository into a second data repository; and
if the data that is associated with the attribute value has been loaded into the second data repository, initiating a search in the second data repository with the attribute value to determine which of the several possible members to include in the target group.

2. The method of claim 1, wherein the search in the second data repository is performed and yields at least one possible member of the several possible members.

3. The method of claim 2, wherein the search involves counting the at least one possible member as being associated with the attribute value.

4. The method of claim 3, further comprising displaying to the user a distribution based on the counting.

5. The method of claim 2, wherein the search comprises identifying the at least one possible member.

6. The method of claim 5, wherein identifying the at least one possible member comprises retrieving at least one identifier for the at least one possible member from the second data repository.

7. The method of claim 6, further comprising using the at least one identifier in including the at least one possible member in the target group.

8. The method of claim 1, wherein the search is an online search.

9. The method of claim 1, wherein the search is interactive, and wherein the user repeatedly chooses different attribute values, there is performed corresponding searches using the different attribute values, and results of the corresponding searches are displayed to the user between the corresponding searches.

10. The method of claim 9, wherein choosing the different attribute values comprises at least one selected from the group consisting of: adding a new attribute value to the chosen attribute value, replacing the chosen attribute value with the new attribute value, choosing the new attribute value for a different attribute, and combinations thereof.

11. The method of claim 1, wherein the first data repository is included in at least one selected from the group consisting of: a master data system, a data warehouse system, a campaign management system, and combinations thereof.

12. The method of claim 11, wherein the input identifies at least one other attribute value in addition to the attribute value, and wherein other data that is associated with the at least one other attribute value is stored in a different system than the first data repository.

13. The method of claim 1, wherein the second data repository is configured such that retrieving information from the second data repository is faster than storing information in the second data repository.

14. The method of claim 1, wherein the search is performed using a sample of the several possible members.

15. The method of claim 1, further comprising creating the target group.

16. The method of claim 15, wherein the target group is created by searching the first data repository to identify at least one of the several possible members that is associated with the attribute value.

17. The method of claim 16, wherein the first data repository is searched using a target group profile that includes the attribute value.

18. The method of claim 1, wherein before receiving the input there is received another input identifying at least one attribute selected among a group of attributes, the at least one attribute being chosen for loading into the second data repository.

19. The method of claim 18, wherein the other input further specifies a time interval for periodically updating the chosen at least one attribute.

20. The method of claim 18, wherein a time interval for periodically updating the chosen at least one attribute is taken into account in choosing the chosen at least one attribute among the group of attributes.

21. The method of claim 1, wherein the input identifies at least one other attribute value in addition to the attribute value.

22. The method of claim 21, wherein if first data that is associated with the at least one other attribute value has been loaded into the second data repository, the method further comprises searching the second data repository using the at least one other attribute value.

23. The method of claim 21, wherein first data that is associated with the at least one other attribute value has not been loaded from the first data repository into the second data repository, further comprising searching the first data repository using the at least one other attribute value.

24. The method of claim 23, wherein the first data repository is searched using a background search.

25. The method of claim 23, further comprising merging a first result from searching the first data repository with a second result from the search performed in the second data repository.

26. The method of claim 25, further comprising displaying a merged result to the user.

27. A computer program product tangibly embodied in an information carrier, the computer program product including instructions that, when executed, cause a processor to perform operations comprising:
receive an input identifying an attribute value chosen by a user for determining which of several possible members to include in a target group, wherein a first data repository contains data about each of the several possible members;
determine whether the data that is associated with the attribute value has been loaded from the first data repository into a second data repository; and
if the data that is associated with the attribute value has been loaded into the second data repository, initiate a search in the second data repository with the attribute value to determine which of the several possible members to include in the target group.

28. A method to be performed when a user is defining a target group for a marketing campaign, the method comprising:
receiving an input identifying attribute values chosen by a user for determining which of several possible members to include in a target group;
if data associated with any of the attribute values has been loaded from a first data repository into a second data repository, initiating a search in the second data repository with those attribute values; and
if there exists a remainder of the attribute values whose data has not been loaded into the second data repository, searching the first data repository with the remainder of the attribute values.

29. The method of claim 28, wherein the first and second data repositories are searched, further comprising merging results of the searches.

30. The method of claim 29, further comprising presenting merged results to the user, the merged results being a distribution.

31. A computer program product tangibly embodied in an information carrier, the computer program product including instructions that, when executed, cause a processor to perform operations comprising:
receive an input identifying attribute values chosen by a user for determining which of several possible members to include in a target group;
if data associated with any of the attribute values has been loaded from a first data repository into a second data repository, initiate a search in the second data repository with those attribute values; and
if there exists a remainder of the attribute values whose data has not been loaded into the second data repository, search the first data repository with the remainder of the attribute values.
